(19) United States
(12) Patent Application Publication
(10) Pub. No.: US 2024/0131772 A1
(43) Pub. Date: Apr. 25, 2024

(54) CONTAINER AND METHOD OF MANUFACTURE

(71) Applicant: RING CONTAINER TECHNOLOGIES, LLC, OAKLAND, TN (US)

(72) Inventors: PAUL VINCENT KELLEY, ARLINGTON, TN (US); MICHAEL GREEN, SOMERVILLE, TN (US); DOUGLAS MILES DYGERT, OLIVE BRANCH, MS (US); DANIEL M. FUTRAL, SOMERVILLE, TN (US)

(73) Assignee: RING CONTAINER TECHNOLOGIES, LLC, OAKLAND, TN (US)

(21) Appl. No.: 17/969,956

(22) Filed: Oct. 19, 2022

(51) Int. Cl. B29C 49/00; B29C 49/06

(52) U.S. Cl. CPC B29C 49/0005; B29C 49/06; B29K 2067/003

(57) ABSTRACT

A method for manufacturing a container includes forming a top portion of a preform by injecting a first material into a mold. A bottom portion of the preform is formed by injecting a second material into the mold to form inner and outer layers of the bottom portion and injecting a third material into the mold to form an intermediate layer of the bottom portion that is positioned between the inner layer and the outer layer. The third material includes virgin polyethylene terephthalate and an additive.

### CROSS-REFERENCE TO RELATED APPLICATIONS

This application is a continuation-in-part of U.S. patent application Ser. No. 17/088,896, filed on Nov. 4, 2020, which claims the benefit of U.S. Provisional Patent Application No. 62/930,220, filed on Nov. 4, 2019. These applications are hereby incorporated herein by reference, in their entireties.

### TECHNICAL FIELD

The present disclosure generally relates to blow-molded containers and more particularly to plastic containers and methods for making the same for food and/or packaging, for example.

### BACKGROUND

Plastic blow-molded containers are commonly used for food and/or beverage packaging products. Many food and beverage products are sold to the consuming public in blow-molded containers. These containers can be made from polyethylene terephthalate or other suitable plastic resins in a range of sizes. The empty blow-molded containers can be filled with food and/or beverage products at a fill site utilizing automated fill equipment.

For example, manufacture of such plastic blow-molded containers can include initially forming plastic resin into a preform, which may be provided by injection molding. Typically, the preform includes a mouth and a generally tubular body that terminates in a closed end. Prior to being formed into containers, preforms are softened and transferred into a mold cavity configured in the shape of a selected container. In the mold cavity, the preforms are blow-molded or stretch blow-molded and expanded into the selected container.

Such plastic blow-molded containers may be produced on single stage injection mold equipment. The single stage blow molding process combines the injection molding of the preform and blowing of the container into one machine. This machine has an extruder that melts resin pellets and injects the molten resin into a mold to create the preform. The preform is transferred to a blow station to form the container and the container is removed from the machine. In some cases, the plastic blow-molded containers are produced with two-stage equipment. The two-stage equipment makes preforms in an injection molding machine and then reheats and blows the preforms into selected containers in a separate blowing machine.

Some conventional plastic blow-molded containers include additives, such as, for example, oxygen scavengers to improve the shelf life of items that are stored in the containers. While such additives may improve the performance of the containers, the additives present challenges for recycling. For example, the relatively high concentrations of the additives used in conventional plastic blow-molded containers often causes yellowing if the conventional plastic blow-molded containers were ground and recycled for use in a new container, thus making conventional plastic blow-molded containers generally unsuitable for being recycled into a new container. Additionally, the resin stream is often the same for conventional plastic blow-molded containers to form both the portion of the container that includes the additive(s) and the portion that does not include the additive(s), thus limiting the ability to use different combinations of virgin polyethylene terephthalate and/or recycled polyethylene terephthalate in the portion of the container that includes the additive(s) and the portion that does not include the additive(s), as discussed in greater detail hereinbelow. This disclosure describes an improvement over these prior art technologies.

### SUMMARY

In one embodiment, in accordance with the principles of the present disclosure, a method for manufacturing a container is provided. The method includes forming a top portion of a preform by injecting a first material into a mold. A bottom portion of the preform is formed by injecting a second material into the mold to form inner and outer layers of the bottom portion and injecting a third material into the mold to form an intermediate layer of the bottom portion that is positioned between the inner layer and the outer layer. The third material comprises virgin polyethylene terephthalate and an additive.

In some embodiments, at least one of the first material and the second material comprises recycled polyethylene terephthalate. In some embodiments, the first material and the second material each comprise recycled polyethylene terephthalate. In some embodiments, at least one of the first material and the second material comprises recycled polyethylene terephthalate and virgin polyethylene terephthalate. In some embodiments, the first material and the second material each comprise recycled polyethylene terephthalate and virgin polyethylene terephthalate. In some embodiments, the third material comprises recycled polyethylene terephthalate, the virgin polyethylene terephthalate and the additive. In some embodiments, the third material comprises recycled polyethylene terephthalate, the virgin polyethylene terephthalate and the additive, the third material having a greater weight percentage of the recycled polyethylene terephthalate than the virgin polyethylene terephthalate. In some embodiments, the third material comprises 75-99% recycled polyethylene terephthalate, 1-25% the virgin polyethylene terephthalate and the additive. In some embodiments, the method comprises blow molding the preform into an intermediate article and processing the intermediate article to produce a finished container. In some embodiments, processing the intermediate article to produce the finished container does not include trimming the intermediate article. In some embodiments, processing the intermediate article to produce the finished container includes trimming the intermediate article. In some embodiments, the additive comprises at least one of the group consisting of catalysts, passive oxygen scavengers, active oxygen scavengers, colorants, calcium carbonate fillers and foaming agents.

In one embodiment, in accordance with the principles of the present disclosure, a method for manufacturing a container is provided. The method includes grinding a polyethylene terephthalate container into a first material. A top portion of a preform is formed by injecting the first material into a mold. A bottom portion of the preform is formed by injecting a second material into the mold to form inner and outer layers of the bottom portion and injecting a third material into the mold to form an intermediate layer of the bottom portion that is positioned between the inner layer and the outer layer. The preform is blow molded into an intermediate article. The intermediate article is processed to produce a finished container. The first material comprises polyethylene terephthalate and a first additive. The third material comprises virgin polyethylene terephthalate and a second additive.

In some embodiments, the second material is different than the first material. In some embodiments, the second material is the same as the first material. In some embodiments, the third material consists of the virgin polyethylene terephthalate and the second additive. In some embodiments, the third material further comprises the first material. In some embodiments, the third material comprises 75-99% of the first material and 1-25% virgin polyethylene terephthalate. In some embodiments, the second material consists of the first material. In some embodiments, the second material consists of the first material and virgin polyethylene terephthalate. In some embodiments, the second material comprises 75-99% of the first material and 1-25% virgin polyethylene terephthalate. In some embodiments, processing the intermediate article to produce the finished container does not include trimming the intermediate article. In some embodiments, processing the intermediate article to produce the finished container includes trimming the intermediate article.

In one embodiment, in accordance with the principles of the present disclosure, a method for manufacturing a container is provided. The method includes grinding a plurality of polyethylene terephthalate containers into a first material. A top portion of a preform is formed by injecting the first material into a mold such that the top portion includes only one layer consisting of the first material. A bottom portion of the preform that is connected to the top portion is formed by injecting the first material into the mold to form inner and outer layers of the bottom portion and injecting a second material into the mold to form an intermediate layer of the bottom portion that is positioned between the inner layer and the outer layer. The preform is blow molded into an intermediate article. The intermediate article is processed to produce a finished container. The first material comprises polyethylene terephthalate and a first additive. The second material comprises 1-25% virgin polyethylene terephthalate, 75-99% polyethylene terephthalate and a second additive. The second additive comprises at least one of the group consisting of catalysts, passive oxygen scavengers, active oxygen scavengers, colorants, calcium carbonate fillers and foaming agents. In some embodiments, processing the intermediate article to produce the finished container does not include trimming the intermediate article. In some embodiments, processing the intermediate article to produce the finished container includes trimming the intermediate article.

### BRIEF DESCRIPTION OF THE DRAWINGS

The present disclosure will become more readily apparent from the specific description accompanied by the following drawings, in which:

FIG. 1 is a side, cross-sectional view of a component of one embodiment of a container system in accordance with the principles of the present disclosure;

FIG. 2 is a side view of a component of one embodiment of a container system in accordance with the principles of the present disclosure;

FIG. 3 is a side view of a component of one embodiment of a container system in accordance with the principles of the present disclosure;

FIG. 3A is a perspective view of a container in accordance with the principles of the present disclosure;

FIG. 4 is a schematic view of a method of manufacturing a container in accordance with the principles of the present disclosure;

FIG. 4A is a side, cross-sectional view of a component of one embodiment of a container system in accordance with the principles of the present disclosure;

FIG. 4B is a side, cross-sectional view of the component shown in FIG. 4A;

FIG. 4C is a side, cross-sectional view of the component shown in FIG. 4A;

FIG. 4D is a side, cross-sectional view of the component shown in FIG. 4A;

FIG. 5 is a side, cross-sectional view of a component of one embodiment of a container system in accordance with the principles of the present disclosure;

FIG. 6 is an enlarged side, cross-sectional view of the component shown in FIG. 5 at detail A of FIG. 5;

FIG. 7 is a side, cross-sectional view of a component of one embodiment of a container system in accordance with the principles of the present disclosure;

FIG. 8 is a side, cross-sectional view of the component shown in FIG. 7;

FIG. 9 is a side, cross-sectional view of a component of one embodiment of a container system in accordance with the principles of the present disclosure;

FIG. 10 is an enlarged side, cross-sectional view of the component shown in FIG. 9 at detail B of FIG. 9;

FIG. 11 is a side, cross-sectional view of a component of one embodiment of a container system in accordance with the principles of the present disclosure;

FIG. 12 is a graph comparing the b* measurement of several containers with the b* measurement of virgin PET;

FIG. 13 is a graph comparing the haze percentage of several containers with the haze percentage of virgin PET; and

FIG. 14 is a graph showing oxygen ingress in a 500 mL bottle over a period of 365 days.

### DETAILED DESCRIPTION

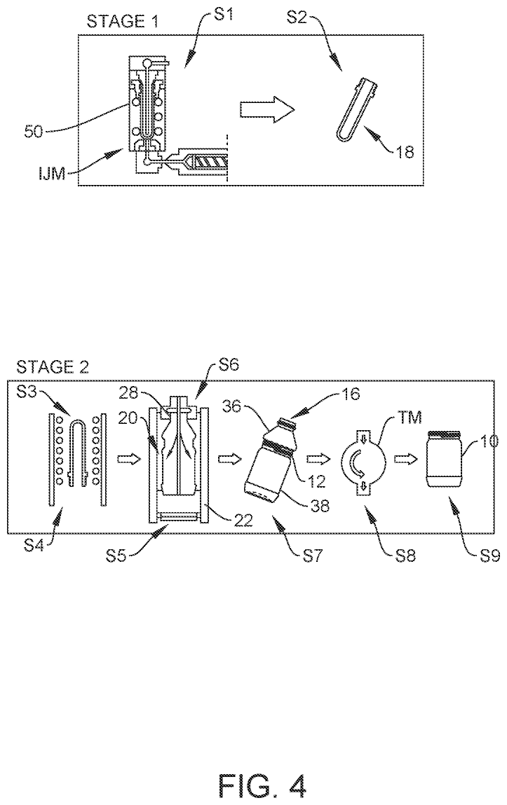

The exemplary embodiments of blow-molded containers and more particularly, plastic containers and methods for making the same are discussed in terms of food packaging products. In some embodiments, the present container is manufactured via an injection molded preform, which is subjected to a blow mold and, in come cases, a trim process (FIG. 3). That is, in some embodiments, the present container is manufactured without being trimmed after being blow molded (FIG. 3A). In some embodiments, the present container can be filled with food, food preparation oils, viscous and/or beverage products. In some embodiments, the present container can be employed as a cold fill container. In some embodiments, the present container can be employed as a hot fill container. In some embodiments, the present container is employed as a light weight, high strength and barrier food packaging product.

Various additives can be used as barrier materials in plastic bottles to perform various functions, such as, for example, extending the shelf life of a product that fills the plastic bottle. However, barrier materials for plastic bottles, such as, for example, polyethylene terephthalate (PET) bottles are priced much higher than the base price for PET. Conventional PET bottles typically include barrier material that makes up 3.0 wt. % to 5.0 wt. % of the PET bottle. To reduce cost, the PET bottles of the present disclosure include much less of the barrier material (e.g., less than 1.0 wt. %) without compromising the shelf life of an unfilled bottle or the shelf life of a product that fills the bottle, as discussed herein. Indeed, it has been found that by selectively positioning a barrier material in a wall thickness of a container such that the barrier material is biased toward a center line of the container and/or concentrating the barrier material such that the barrier material comprises less than 0.1 wt. % of the container results in a container that has an unfilled shelf life or a product shelf life that is greater than an unfilled shelf life or a product shelf life of a container having a barrier material that is not biased toward a center line of the container and/or having unconcentrated barrier material such that the barrier material comprises more than 0.1 wt. % of the container. As such, by selectively positioning a barrier material in a wall thickness of a container such that the barrier material is biased toward a center line of the container and/or concentrating the barrier material such that the barrier material comprises less than 0.1 wt. % of the container, less of the barrier material can be used, while still having the same or greater unfilled and filled shelf life. For example, in some embodiments, the bottles of the present disclosure include between 0.01 wt. % and 0.1% of the barrier material. In some embodiments, the bottles of the present disclosure include between 0.01 wt. % and 0.05% of the barrier material. In some embodiments, the bottles of the present disclosure include between 0.01 wt. % and 0.04% of the barrier material. In some embodiments, the bottles of the present disclosure include between 0.03 wt. % and 0.05% of the barrier material. This has a significant impact upon the ability to be recycled and reused to make another plastic container. Indeed, when containers that have high concentrations of oxygen scavengers and/or other additives (greater than 0.1 wt. % of the container) are recycled, the oxygen scavengers and/or other additives cause a new container made from such recycled containers to have an undesirable yellowish (not transparent or clear) appearance. However, due to the reduced the amount of oxygen scavengers and/or other additives, the containers disclosed herein can be recycled into new containers without producing a yellowing effect or other undesirable qualities in the new containers.

In some embodiments, the bottles of the present disclosure are manufactured using an injection molding machine with a material hot runner and injection process that can inject 2 or more materials from 2 or more extruders. Polyethene terephthalate copolymer resin ranging from an IV of 0.72 up to 0.85 for injection stretch blow molding are used to form a top section of a preform and inner and outer portions of a bottom section of the preform, as discussed herein. It has been found that these resins do not impact the overall barrier performance of the finished container. An intermediate portion of the preform comprises Polyethene terephthalate copolymer resins with a cobalt catalyst an oxidizable co-polyester active barrier component between 0.01 wt. % and 0.1% of the finished container, between 0.01 wt. % and 0.05% of the finished container, between 0.01 wt. % and 0.04% of the finished container, or between 0.03 wt. % and 0.05% of the finished container. The preform is blow molded on a two stage platform. In some embodiments, the finished container comprises 90% Polyethene terephthalate copolymer commodity PET resin and the barrier portion of the finished container comprises 10 wt. % comprised of 96% Polyethene terephthalate copolymer resins with a cobalt catalyst and 4% of oxidizable co-polyester active barrier.

In some embodiments, the top section of the preform and the inner and outer portions of the bottom section of the preform are formed using a first material, such as a material obtained by recycling PET containers, and the intermediate portion of the preform is formed using a second material and at least one additive, such as, for example, one or more oxygen scavengers. The second material is different than the first material and includes virgin PET. In some embodiments, the first material is free of virgin PET and the second material includes virgin PET. In some embodiments, the first and second materials each include virgin PET, wherein the second material includes more virgin PET than the first material. That is, the second material has a higher percentage, by weight, for example, of virgin PET than the first material. As discussed herein, the at least one additive may include additives, such as, for example, one or more cobalt catalysts, in addition to oxygen scavengers. In some embodiments, the term “virgin PET” refers to a material that consists solely of PET. That is, virgin PET does not include any additives, such as, for example, the additives discussed above.

As discussed above, the first material includes at least some recycled PET bottles that have been ground and optionally mixed to produce the first material. It is envisioned that the second material may also include at least some recycled PET bottles that have been ground and optionally mixed to produce the second material. However, in embodiments wherein both the first and second materials include at least some recycled PET bottles that have been ground and optionally mixed, the first material includes more (a higher percentage by weight, for example) recycled PET bottles that have been ground and optionally mixed than the second material. As discussed herein, the additives used in PET bottles cause recycled PET bottles that have been ground and optionally mixed to cause yellowing when used to produce new PET bottles. As such, the amount of recycled PET bottles used in the first material and the second material must be limited to prevent the yellowing effect. That is, the amount and/or ratio of virgin PET (if any) and recycled PET used in the first material is used to optimize cost via the lower cost recycled PET and higher cost virgin PET such that the first material includes only as much virgin PET necessary to prevent a yellowing effect.

Furthermore, in that certain additives used in conventional PET bottles, such as phosphorus, antimony and titanium, for example, may react negatively with the additives used to form the intermediate portion of the preform of the present disclosure, it is important to eliminate or limit the amount of recycled PET bottles used in the second material. That is, it has been found that if the second material included 100% recycled PET bottles (no virgin PET), that the oxygen barrier, for example, formed by the additives in the intermediate portion of the preform would be much less effective than if the second material included at least some virgin PET, as discussed in greater detail hereinbelow. As such, the amount and/or ratio of virgin PET and recycled PET (if any) used in the second material is used to optimize cost via the lower cost recycled PET and higher cost virgin PET such that the first material includes only as much virgin PET necessary to prevent a yellowing effect and only as much recycled PET so as not to negatively affect any oxygen scavenging effect, for example, of the additive(s) in the intermediate portion of the preform.

In some embodiments, the preform of the present disclosure has a concentrated barrier region 0.94 mm (0.036 in.) to 1.27 mm (0.050 in.). In some embodiments, the concentrated barrier region is positioned towards a central axis from 10%-30% from an inner wall of the preform. In some embodiments, the concentrated barrier region contains 0.1%-1.0% barrier additive and is 0.01%-0.1% total weight percentage. In some embodiments, the concentrated barrier region contains 0.1%-0.5% barrier additive and is 0.01%-0.05% total weight percentage. In some embodiments, the concentrated barrier region contains 0.1%-0.4% barrier additive and is 0.01%-0.04% total weight percentage. In some embodiments, the concentrated barrier region contains 0.3%-0.5% additive and is 0.03%-0.05% total weight percentage. In some embodiments, the concentrated barrier region is below the threaded neck finish area of the preform. That is, the threaded neck finish area is spaced apart from the concentrated barrier region such that the concentrated barrier region does not extend into the threaded neck finish area.

In some embodiments, the finished container of the present disclosure has an overall wall thickness of 0.45 mm (0.018 in.). In some embodiments, the finished container of the present disclosure has a concentrated barrier region with a thickness between 0.15 mm (0.006 in.) and 0.04 mm (0.002 in.). The barrier region of the finished container of the present disclosure is concentrated such that a thickness of the barrier region of the finished container of the present disclosure will contain more of the barrier material than the same thickness of a container wherein the barrier region is not concentrated. In some embodiments, the barrier region of the finished container of the present disclosure is concentrated such that a thickness of the barrier region of the finished container of the present disclosure has a density that is greater than the same thickness of a container wherein the barrier region is not concentrated. It is envisioned that the increased density of the barrier region of the finished container of the present disclosure will allow active barrier materials (e.g., active oxygen scavengers) to also act as passive barrier materials (e.g., passive oxygen scavengers). That is, due to the increased density of the barrier region, caused by the concentrated barrier materials, oxygen is unable to physically move through the barrier region of the finished container of the present disclosure. This is not possible where the barrier material is not concentrated. That is, when the barrier material is not concentrated, oxygen is permitted to move through/across the barrier region. In some embodiments, the concentrated barrier region is positioned towards central axis from 10%-30% from inner wall. In some embodiments, the concentrated barrier region contains 0.5%-5.0% additive and is 0.1%-1.0% total weight percentage. In some embodiments, the concentrated barrier region contains 1.0%-4.0% additive and is 0.05%-0.5% total weight percentage. In some embodiments, the concentrated barrier region contains 1%-4% additive and is 0.01%-0.04% total weight percentage. In some embodiments, the concentrated barrier region contains 3.0%-5.0% additive and is 0.03%-0.05% total weight percentage. In some embodiments, the concentrated barrier region is below the threaded neck finish area of the preform. That is, the concentrated barrier region does not extend into the threaded neck finish area.

In some embodiments, the present disclosure involves a two phase injection system. In one phase of the two phase injection system, PET or virgin PET is injected to form a top portion of a preform. It is envisioned that post-consumer material may be used in this phase. That is, the top portion of the preform may be used using only virgin PET, only post-consumer material, or a combination of virgin PET and post-consumer material. In some embodiments, post-consumer material refers to all or a portion of a PET container that has been filled with a substance and wherein a consumer has subsequently removed the substance from the container, leaving only the material that forms the container. That is, post-consumer material is material recycled by the consumer for reuse in another application.

In another phase of the two phase injection system, a bottom of the preform if formed that comprises multiple regions, at least one of the multiple regions including an additive. In particular, the bottom portion of the preform is formed to connect with the top portion of the preform and includes opposite inner and outer layers or portions and an intermediate layer or portion between the inner and outer layers. The intermediate layer includes at least one additive, as discussed herein. The inner and outer layers are formed using a first material, such as, for example, the material that is used to form the top portion of the preform. However, it is envisioned that the first material may be different than the material that is used to form the top portion of the preform. For example, the first material may have a higher or lower ratio of virgin PET to post-consumer material than the material that is used to form the top portion of the preform.

The intermediate layer is formed using a second material and one or more additives, such as, for example, one or more oxygen scavengers and/or catalysts, such as, for example, cobalt catalysts. In some embodiments, the second material is the same as the first material. In some embodiments, the second material is different than the first material. In some embodiments, the second material includes virgin PET. In some embodiments, the second material includes virgin PET and post-consumer material. In embodiments wherein the first and second materials each include virgin PET and post-consumer material, it is envisioned that the second material will have a higher amount or ratio, by weight, for example, of virgin PET than the first material. In some embodiments, the phase in which the bottom portion of the preform is formed and the multiple regions are produced begins after the first phase that forms the top portion of the preform is completed.

It is envisioned that the present disclosure may be useful for manufacturers that run multiple sizes of bottles for various end uses. For example, the present disclosure may be useful to produce containers for food items, such as, for example, dressings, sauces and peanuts, wherein oxygen permeation through the side walls of the container negatively affect shelf life and/or product flavor. It is envisioned that the present disclosure may be useful to produce containers for food items, such as, for example, non-dairy coffee creamers that require color pigment for both fill-line concealment and product protection against UV light penetration. Other containers that can be made from the disclosed process include containers for mayonnaise, salad dressings, peanuts as well as other condiments and/or food products.

In some embodiments, the method includes the step of testing the one or more preforms to ensure the one or more preforms include a selected weight and selected neck finish dimension. In some embodiments, the method includes the step of employing the one or more preforms with a multiple cavity production mold. In some embodiments, the method includes the step of blow molding the one or more preforms into an intermediate article, which may comprise a container. In some embodiments, the method includes the step of trimming the intermediate article (FIG. 3). In some embodiments, the step of trimming includes a spin trim operation to remove a dome from the intermediate article. In some embodiments, the method includes a two-stage blow molding process such that the one or more preforms are injection molded and stored before blowing the one or more preforms to produce a container. In some embodiments, the method does not include the step of trimming the intermediate article (FIG. 3A). That is, a finished container is produce and ready to fill with a product, such as, for example, food, without trimming the preform or the intermediate article. For example, in some embodiments, the intermediate article is not trimmed after blowing the preform into the intermediate article.

In some embodiments, the present container is manufactured by including an oxygen scavenger and/or oxygen barrier material in the intermediate layer or portion of the preform. In some embodiments, the oxygen scavenger and/or oxygen barrier material is concentrated or unconcentrated in the intermediate layer or portion of the preform such that the oxygen scavenger and/or oxygen barrier material is present in the finished container. In some embodiments, the container comprises one or more regions having an oxygen barrier material, wherein the oxygen barrier material is concentrated or unconcentrated. In some embodiments, the oxygen barrier material is present in the container in an amount less than about 1.0 wt. % of the container. In some embodiments, the oxygen barrier material comprises between about 0.01 wt. % of the container and 0.1 wt. % of the container. In some embodiments, the oxygen barrier material comprises between about 0.01 wt. % of the container and 0.05 wt. % of the container. In some embodiments, the oxygen barrier material comprises between about 0.01 wt. % of the container and 0.04 wt. % of the container. In some embodiments, the oxygen barrier is a passive barrier and is unreactive with oxygen. In some embodiments, the oxygen barrier is an oxygen scavenger and is reactive with oxygen to capture the oxygen. In some embodiments, the oxygen barrier is an oxygen scavenger that is reactive with oxygen to capture the oxygen and may also act as a passive oxygen scavenger due to the concentration of the oxygen barrier. For example, active oxygen scavengers, when concentrated, may provide a physical barrier that prevents oxygen to move through the barrier. Thus is due, at least in part, to the increased density of the oxygen barrier caused by concentrating the material that forms the oxygen barrier (e.g., the oxygen scavenger). In some embodiments, the oxygen scavenger includes one or more oxygen barrier, such as, for example, one or more polymers, metals, compatibilizers, catalysts, and/or fatty acid salts.

In some embodiments, the present manufacturing method provides PET enhancements via improved material orientation with selective physical performance features, such as, for example, improved top load performance, improved vacuum resistance performance and/or hoop strength, improved O₂ performance, improved moisture vapor transmission rate (MVTR) performance. In some embodiments, the enhancements include modifications to the manufacturing process or the addition of additives to provide a container made of PET that has a selected crystallinity, as discussed herein.

In some embodiments, the method is configured to produce a container that has a crystallinity of about 10%. In some embodiments, the method is configured to produce a container that has a crystallinity between about 15% and about 20%. In some embodiments, the preform is heated and stretched to produce a container having a crystallinity between about 18% and about 30%. In some embodiments, the preform is heated and stretched to produce a container having a crystallinity between about 20% and about 40%. In some embodiments, the preform includes a molecular weight between about 120,000 g/mol and about 240,000 g/mol. In some embodiments, the preform includes a molecular weight between about 250,000 g/mol and about 450,000 g/mol. In some embodiments, the preform comprises PET and has an axial stretch ratio of about 1.8 to 1 to about 2.4 to 1.

The present disclosure may be understood more readily by reference to the following detailed description of the embodiments taken in connection with the accompanying drawing figures, which form a part of this disclosure. It is to be understood that this application is not limited to the specific devices, methods, conditions or parameters described and/or shown herein, and that the terminology used herein is for the purpose of describing particular embodiments by way of example only and is not intended to be limiting. Also, in some embodiments, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”.

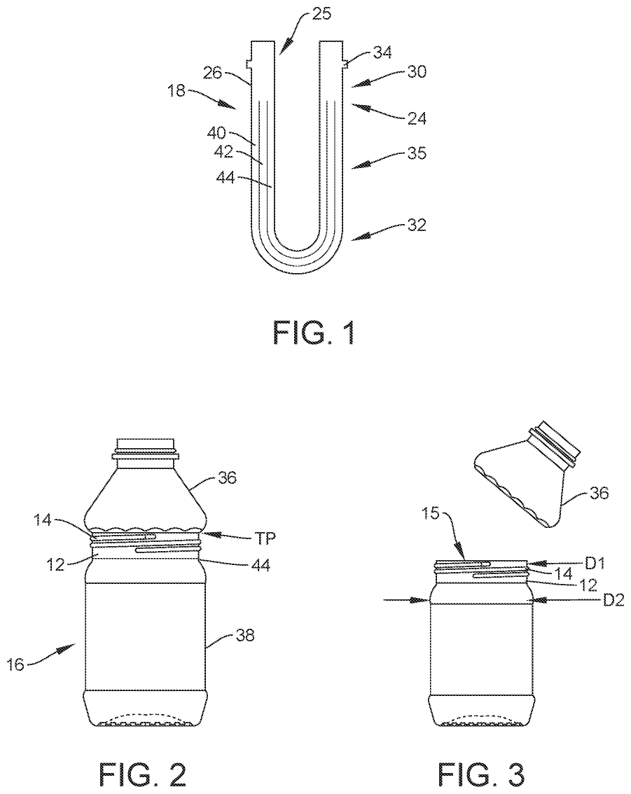

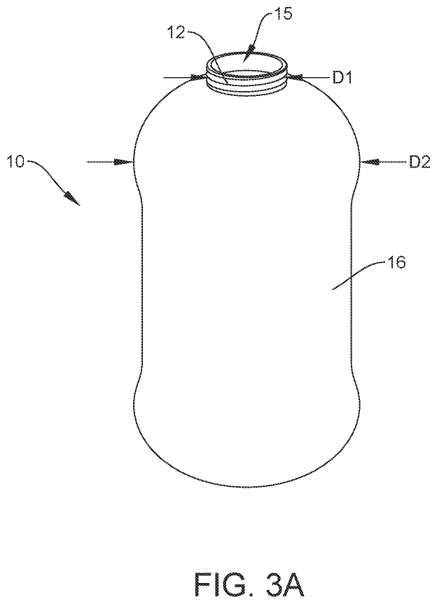

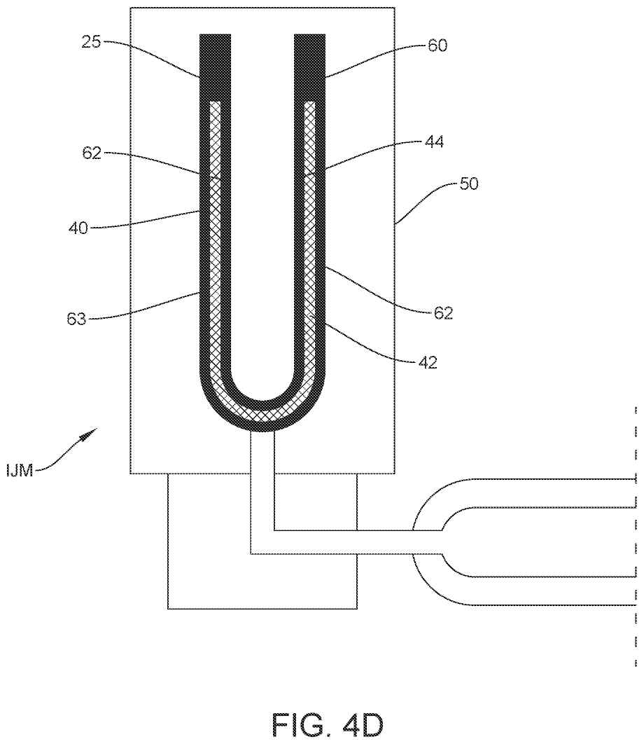

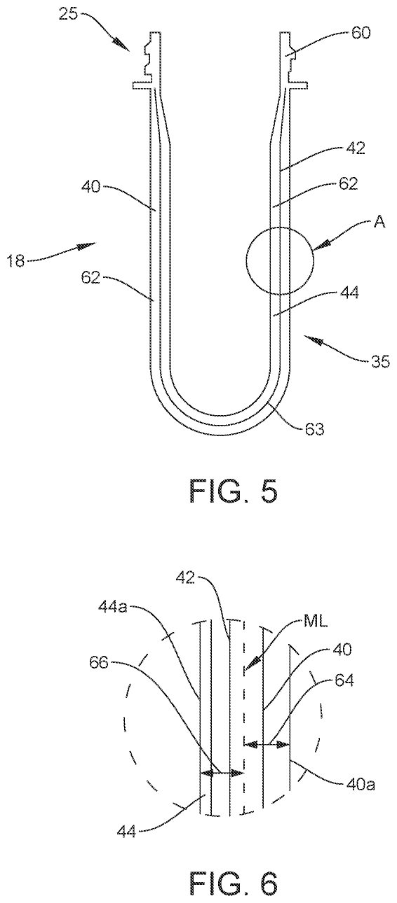

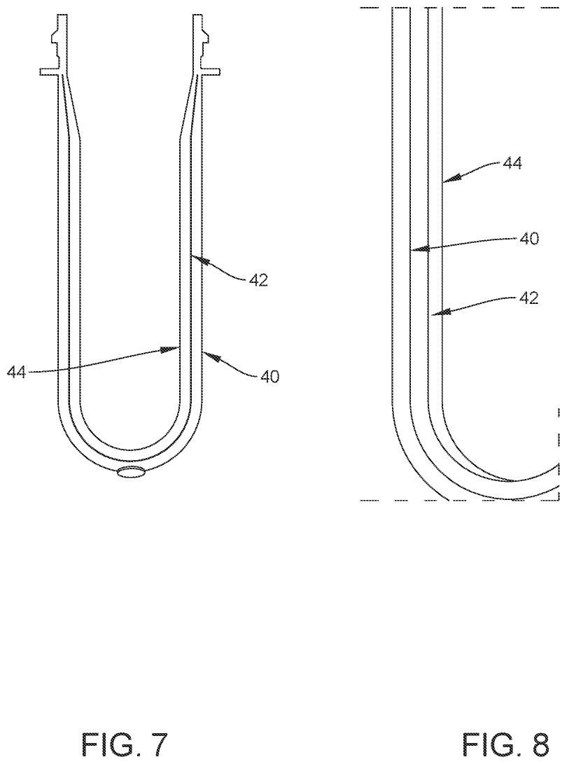

The following discussion includes a description of a container system for producing food packaging products, a container, related components and methods of manufacturing a container with an injection molded preform. Alternate embodiments are also disclosed. Reference is made in detail to the exemplary embodiments of the present disclosure, which are illustrated in the accompanying figures. Turning to FIGS. 1-14, there are illustrated components of a container system, methods of manufacturing a container and graphics related to the same.

A finished blow-molded container 10, as shown in FIG. 3, is constructed for use with a selected application, as described herein. In some embodiments, finished container 10 is a wide-mouth container. In some embodiments, finished container 10 comprises a narrow neck and is suitable for packaging ketchup, for example. Indeed, in some embodiments, finished container 10 is a ketchup bottle. In some embodiments, the selected application includes food, food preparation oils, viscous and/or beverage products. It is envisioned that finished container 10 may include any size and shape and may be filled with any type of food and/or beverage. In some embodiments, finished container 10 is configured for use for applications that do not include foods and/or beverages.

In some embodiments, container 10 comprises a cylindrical threaded neck 12 wherein an outer diameter has a continuous thread 14. Neck 12 defines an opening 15 that is in communication with a cavity of container 10. In some embodiments, neck 12 has a diameter D1 that is between 5% and 75% less than a maximum diameter D2 of container 10. In some embodiments, D1 is between 5% and 65% less diameter D2. In some embodiments, D1 is between 5% and 50% less diameter D2. In some embodiments, D1 is between 5% and 35% less diameter D2. In some embodiments, D1 is between 5% and 25% less diameter D2. In some embodiments, D1 is between 5% and 20% less diameter D2. In some embodiments, D1 is between 5% and 15% less diameter D2. In some embodiments, D1 is between 5% and 10% less diameter D2.

In some embodiments, container 10 is manufactured via a two-stage method, as described herein. In some embodiments, container 10 is manufactured via a single stage method, as described herein. In some embodiments, container 10 is produced as a lower part of an intermediate article 16, as shown in FIG. 3. In some embodiments, container 10 is produced as the entire intermediate article 16, as shown in FIG. 3A. In some embodiments, container 10 is formed by injection molding a preform 18 and then placing preform 18 into a cavity of a mold assembly, to be blown into finished container 10 without any trimming involved, as described herein. That is, finished container 10, including the neck and/or threaded portion are formed by blow molding preform 18 into finished container 10 without the need to trim any part of preform 18, intermediate article 16, or finished container 10.

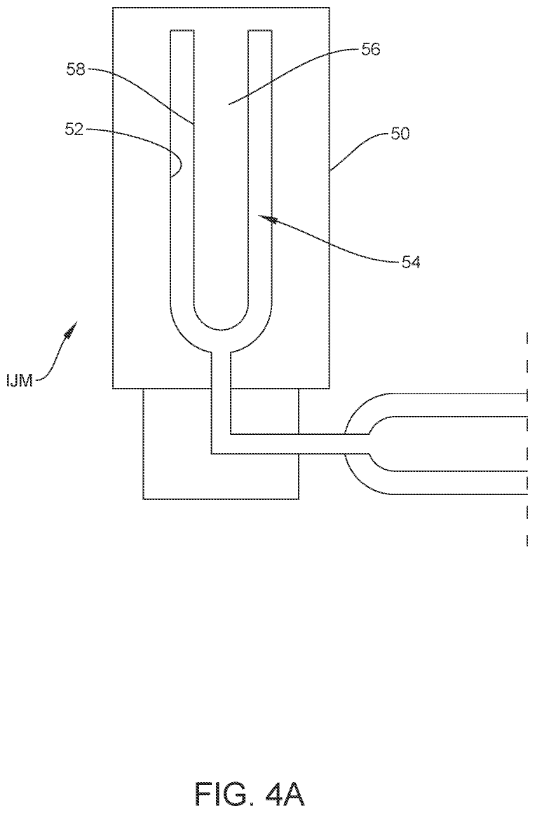

In some embodiments, container 10 is manufactured via a two-stage method, as shown in FIG. 4. In some embodiments, an initial step S1 includes injection molding preform 18 in an injection molding machine IJM during a first stage of the manufacturing operation. Preform 18 has a thread forming surface 24 below a preform neck 26. In some embodiments, preform 18 has thread forming surface 24, which includes a portion of preform 18 below neck 26 that will press against mold assembly 22 to form neck 12 and thread 14. In some embodiments, container 10 may be manufactured with a snap fit portion, spiral threads and/or a beaded rim in place of or in addition to thread forming surface 24. In some embodiments, preform 18 can be injection molded with a neck diameter smaller than the neck diameter of container 10, such that a diameter of an opening 28 at a top of mold assembly 22 is substantially reduced. As such, a plurality of mold cavities may be placed in mold assembly 22 of a blow machine of the two-stage equipment to provide improved production capacity. In some embodiments, container 10 may be manufactured with a hoop stretch ratio in a range of about 1.6 to 1 to about 2.0 to 1. In some embodiments, a step S2 includes removing preform 18 from machine IJM.

In some embodiments, injection molding preform 18 comprises injection molding preform 18 using a two phase injection system, wherein a first phase of the two phase injection system comprises injecting a first material 60, such as for example, PET or virgin PET, into a mold 50 of injection molding machine IJM to form a top portion 25 of preform 18 such that top portion 25 includes only one portion that is made solely from first material 60. It is envisioned that first material 60 may include recycled PET, such as, for example, the post-consumer material described herein. For example, first material 60 may a percentage, by weight, for example, of post-consumer material and a percentage, by weight, for example, of virgin PET, wherein the amount of post-consumer material in first material 60 ranges from 0-100% and the amount of virgin PET in first material ranges from 0-100%. In some embodiments, first material 60 comprises a greater percentage of post-consumer material than virgin PET. In some embodiments, first material 60 comprises between 50-99% post-consumer material and between 1-50% virgin PET. In some embodiments, first material 60 comprises between 60-99% post-consumer material and between 1-40% virgin PET. In some embodiments, first material 60 comprises between 70-99% post-consumer material and between 1-30% virgin PET. In some embodiments, first material 60 comprises between 80-99% post-consumer material and between 1-20% virgin PET. In some embodiments, first material 60 comprises between 90-99% post-consumer material and between 1-10% virgin PET.

A second phase of the two phase injection system comprises injecting a second material 62 and a third material 63 to form a bottom portion 35 of preform 18 such that bottom portion 35 includes an outer portion 40 made of second material 62, an intermediate portion 42 made of third material 63 and one or more additives and an inner portion 44 made of second material 62. In some embodiments, top portion 25 is formed before bottom portion 35 is formed. That is, bottom portion 35 is not formed until after top portion 25 is formed.

In some embodiments, second material 62 is the same as first material 60. In some embodiments, second material 62 is different than first material 60. In some embodiments, second material 62 and first material 60 each include post-consumer material. In some embodiments, one of second material 62 and first material 60 includes post-consumer material and the other one of second material 62 and first material 60 does not. In some embodiments, second material 62 and first material 60 each include virgin PET. In some embodiments, one of second material 62 and first material 60 includes virgin PET and the other one of second material 62 and first material 60 does not. In some embodiments, second material 62 and first material 60 each include virgin PET and post-consumer material, wherein second material 62 includes a higher percentage, by weight, for example, of virgin PET than first material 60. In some embodiments, second material 62 and first material 60 each include virgin PET and post-consumer material, wherein second material 62 includes a lower percentage, by weight, for example, of virgin PET than first material 60.

In some embodiments, third material 63 is the same as second material 62 and/or first material 60. In some embodiments, third material 63 is different than second material 62 and first material 60. In some embodiments, third material 63 includes virgin PET. Indeed, as discussed above, it has been found that additives used in PET bottles that are recycled to obtain the post-consumer material inhibit the performance of certain additives, such as, for example, oxygen scavengers. That is, the additives used in PET bottles that are recycled to obtain the post-consumer material will reduce or eliminate the ability of oxygen scavengers to prevent the migration of oxygen through the wall of a container. As such, in some embodiments, third material 63 includes at least some virgin PET to eliminate or reduce the amount of additives that may have a negative effect to the additives used in container 10. In some embodiments, third material 63 consists of virgin PET. In some embodiments, third material 63 comprises virgin PET and post-consumer material. In some embodiments, third material 63 comprises virgin PET and post-consumer material, wherein third material 63 comprises more virgin PET than post-consumer material. In some embodiments, third material 63 comprises virgin PET and post-consumer material, wherein third material 63 comprises less virgin PET than post-consumer material. In embodiments wherein first material 60 and third material 63 each include virgin PET, third material 63 includes more (a higher percentage, by weight, for example) virgin PET than first material 60. In some embodiments wherein second material 62 and third material 63 each include virgin PET, third material 63 includes more (a higher percentage, by weight, for example) virgin PET than second material 62. In some embodiments wherein first material 60 and third material 63 each include post-consumer material, third material 63 includes less (a lower percentage, by weight, for example) post-consumer material than first material 60. In embodiments wherein second material 62 and third material 63 each include post-consumer material, third material 63 includes less (a lower percentage, by weight, for example) post-consumer material than second material 62.

In some embodiments, the additive(s) included in intermediate portion 42 are dispersed within third material 63. That is, in some embodiments, the additive(s) to be included in intermediate portion 42 are mixed with third material 63 before third material 63 is injected into mold 50 with the additives to form intermediate portion 42. In some embodiments, the additive(s) included in intermediate portion 42 include(s) one or more passive oxygen scavengers, one or more active oxygen scavengers, one or more colorants, one or more calcium carbonate fillers and/or one or more foaming agents. In some embodiments, the additive(s) is/are concentrated in intermediate portion 42. In some embodiments, the additive(s) include(s) MXD6+Butadiene. In some embodiments, the additive(s) include(s) active oxygen scavengers, such as, for example, Butadiene, PTMEG-PET Copolymer, and Nylon. In some embodiments, the additive(s) include(s) passive oxygen scavengers, such as, for example, nylon-MXD7, MXD6 and Di-imide. In some embodiments, the additive(s) include(s) catalytic oxygen scavengers, such as, for example, bor-hydride.

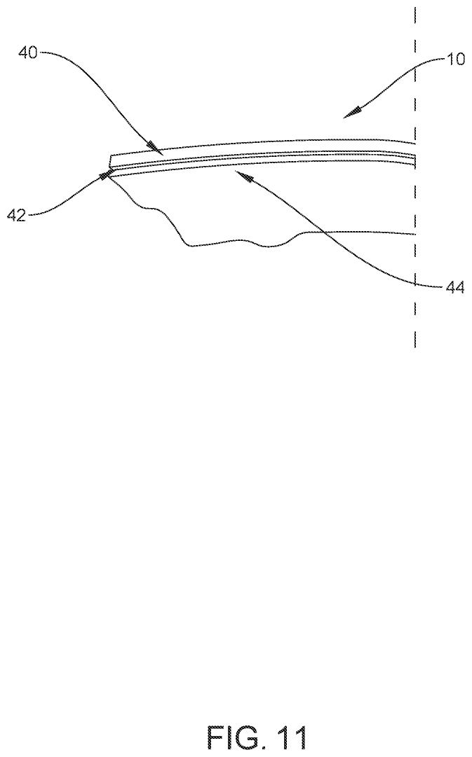

The concentration discussed above refers to the concentration of additive(s) (e.g., an active scavenger) in a specific area of preform 18, intermediate article 16 and/or finished container 10. For example, as shown in FIG. 11, layers 40 and 44 are both made using polyester such that 90% of the total container weight is polyester. In some embodiments, material 62 that forms layers 40, 42 is free of additives that are oxygen scavengers, such as, for example, active oxygen scavengers. In some embodiments, layer 42 may include additional additives for aesthetic purposes or container performance improvements. In some embodiments, layer 42 comprises 10% of the total container weight. Within layer 42, the active scavenger is dispersed. By concentrating the additive(s) within layer 42, the additive(s) (e.g., active scavenger) is in a smaller area than if the additive(s) were dispersed into layers 40, 42 and 44.

In some embodiments, mold 50 includes an inner surface 52 defining a cavity 54. A block 56 is positioned in cavity 54, as shown in FIG. 4A. First material 60 is injected into cavity 54 by a first extruder of injection molding machine IJM such that first material 60 fills a space between inner surface 52 and outer surface 58 at a top portion of mold 50 to form top portion 25, as shown in FIG. 4B. First material 60 is injected into cavity 54 by the first extruder such that first material 60 accumulates along inner surface 52 to form outer portion 40 and accumulates along outer surface 58 to form inner portion 44. At this point, preform 18 includes a liquid L between outer portion 40 and inner portion 44, as shown in FIG. 4C. Second material is injected into cavity by a second extruder of injection molding machine IJM such that second material 62 replaces liquid L to form layers 40, 44, as shown in FIG. 4D. Third material 63 (and any additives dispersed therein) is/are injected into cavity 54 by a third extruder of injection molding machine IJM such that third material 62 replaces liquid L to form layer 42, as shown in FIG. 4D. In some embodiments, second material 62 and third material 63 are injected simultaneously such that layers 40, 42, 44 are formed simultaneously. In some embodiments, second material 62 and third material 63 are injected sequentially such that layers 40, 42, 44 are formed sequentially. In some embodiments, back pressure from the first extruder drives second material 62 and/or third material 63 away from top section 25 and toward the bottom of preform 18. In some embodiments, the position of intermediate portion 42 relative to outer portion 40 and inner portion 44 can be selected by varying the actual injection timing of the second and third extruders, varying the velocity that the second and extruders injects second material 62 and third material 63 into mold 50 and/or varying the temperature and/or viscosity of first material 60, second material 62 and/or third material 63.

In some embodiments, the first extruder injects first material 60 into mold 50 continuously until top portion 25 of preform 18 is fully formed. That is, the first extruder does not stop injecting first material 60 after top portion 25 is formed. Rather, the first extruder continues to inject first material 60 into mold after top portion 25 is formed. In some embodiments, the second extruder begins to inject second material 62 into mold 50 and/or the third extruder begins to inject third material 63 into mold 50 after the first extruder beings to inject first material 60 into mold 50. In some embodiments, the second extruder injects second material 62 into mold 50 and/or the third extruder begins to inject third material 63 into mold 50 at the same time that the first extruder injects first material 60 into mold 50. In some embodiments, the second extruder injects second material 62 into mold 50 to form portions 40, 42 simultaneously as the third extruder injects third material 63 into mold 50 to form portion 42. In some embodiments, the second extruder injects second material 62 into mold 50 to form portions 40, 42 before the third extruder injects third material 63 into mold 50 to form portion 42. In some embodiments, the second extruder injects second material 62 into mold 50 to form portions 40, 42 after the third extruder injects third material 63 into mold 50 to form portion 42.

In some embodiments, portion 42 of preform 18 comprises between 1% and 20% or at least about 20% of a wall thickness of preform 18, wherein the wall thickness of preform 18 is defined by the combined thicknesses of portions 40, 42, 44 of preform 18 In some embodiments, portion 42 of preform 18 comprises between 1% and 5% of the wall thickness of preform 18. In some embodiments, portion 42 of preform 18 comprises between 5% and 10% of the wall thickness of preform 18. In some embodiments, portion 42 of preform 18 comprises between 10% and 15% of the wall thickness of preform 18. In some embodiments, portion 42 of preform 18 comprises between 15% and 20% of the wall thickness of preform 18. In some embodiments, portion 42 of preform 18 comprises between 20% and 25% of the wall thickness of preform 18. In some embodiments, portion 42 of preform 18 comprises between 25% and 30% of the wall thickness of preform 18. In some embodiments, portion 42 of preform 18 comprises between 30% and 35% of the wall thickness of preform 18. In some embodiments, portion 42 of preform 18 comprises greater than 35% of the wall thickness of preform 18.

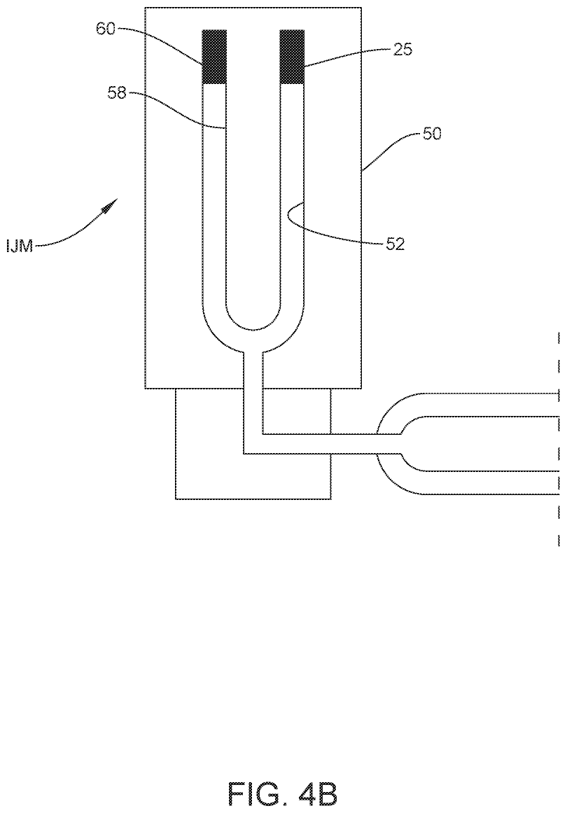

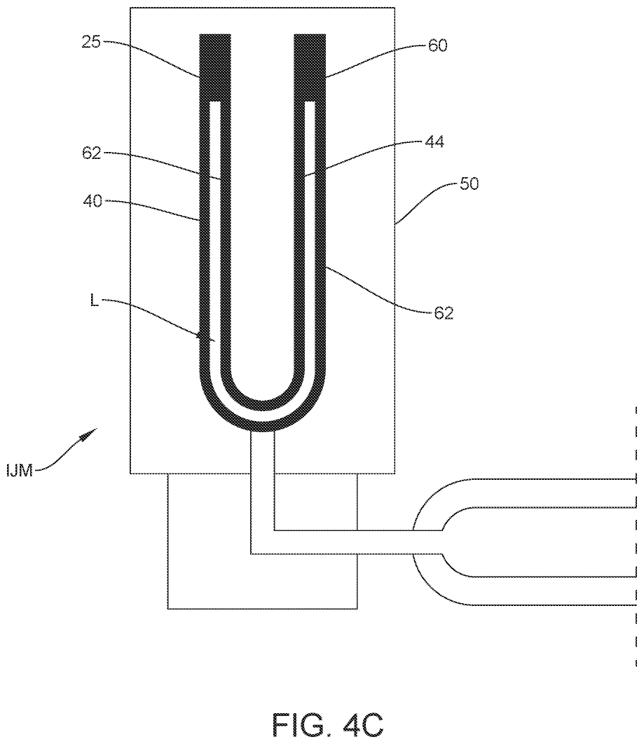

In some embodiments, portion 42 is positioned equidistant between an inner surface 44a of portion 44 and an outer surface 40a of portion 40, as shown in FIG. 1. In some embodiments, portion 42 is positioned closer to outer surface 40a of portion 40 than inner surface 44a of portion 44. In some embodiments, portion 42 is positioned closer to inner surface 44a of portion 44 than outer surface 40a of portion 40, as shown in FIGS. 5-8. For example, the wall thickness of preform 18 includes a midline ML equidistant between outer surface 40a and inner surface 44a, as shown in FIG. 6. Preform 18 includes a first portion 64 extending from outer surface 40a to midline ML and a second portion 66 extending from inner surface 44a to midline ML. Portion 42 is positioned in second portion 66. In some embodiments, portion 42 is positioned solely in second portion 66 such that no part of portion 42 is positioned in first portion 64. It is envisioned that portion 42 may be positioned closer or farther from inner surface 44a, while still being positioned exclusively in second portion 66. In some embodiments, portion 42 is positioned closer to inner surface 44a than midline ML, while still being positioned exclusively in second portion 66. In some embodiments, portion 42 is positioned 5% to 50% closer to inner surface 44a than outer surface 40a. In some embodiments, portion 42 is positioned 5% to 40% closer to inner surface 44a than outer surface 40a. In some embodiments, portion 42 is positioned 5% to 35% closer to inner surface 44a than outer surface 40a. In some embodiments, portion 42 is positioned 10% to 30% closer to inner surface 44a than outer surface 40a.

In some embodiments, portion 40 has a thickness that is greater than a thickness of portion 44 due to the inward biasing of portion 42. In some embodiments, the thickness of portion 40 is equal to the combined thickness of portions 40, 42. In some embodiments, the thickness of portion 40 greater than the combined thickness of portions 40, 42. In some embodiments, the thickness of portion 40 less than the combined thickness of portions 40, 42.

It is envisioned that the inward biasing of portion 42 and/or concentrating the additive and/or barrier material allows container 10 to be manufactured using less additive or barrier material versus containers with centrally positioned barrier portions and/or containers without concentrated additives and/or barrier materials, without compromising the shelf life of container 10 or the shelf life of a product within container 10. That is, the shelf life of container 10 will be the same or longer than the shelf life of a container with a centrally positioned barrier portion and/or a container without concentrated additives or barrier materials. As discussed above, material 62 forms a barrier a barrier layer. In that material 62 is concentrated, the barrier layer formed by concentrated material 62 is denser than a barrier layer formed by an unconcentrated material 62.

As discussed above, the increased density of the barrier layer formed by material 63 (and the additive(s) dispersed therein) allows the additive(s), such as, for example, an oxygen scavenger, to act simultaneously as an active oxygen scavenger and a passive oxygen scavenger. For example, the oxygen scavenger will act as an active oxygen scavenger based on its chemical characteristics. The density of the barrier layer formed by concentrated additive(s) dispersed within material 63 is high enough to act as a physical barrier that prevents oxygen from moving through/across the barrier layer.

In some embodiments, the inward biasing of portion 42 is accomplished by injecting first material 60 into mold 50 via the first extruder while simultaneously injecting second material 62 into mold 50 via the second extruder and injecting third material 63 (and the additive(s) dispersed therein) into mold via the third extruder. A gate pin in a nozzle housing of mold 50 is offset to create an unequal flow of first material 60 from the first extruder. In some embodiments, offsetting the gate pin directs more of first material 60 toward inner surface 52 than outer surface 58. As such, more of first material 60 will accumulate along inner surface 52 than outer surface 58 such that portion 40 is thicker than portion 44. For example, portion 40 can make up the entirety of portion 64, while portion 44 makes up only a part of portion 66. In some embodiments, offsetting the gate pin causes the flow of second material 62 from the second extruder to move into to a side of cavity 54 that has lower pressure. The position of the second extruder is monitored and adjusted via servo controls, if necessary.

In some embodiments, preform 18 does not include a sprue when preform 18 is introduced into a cavity 20 of mold assembly 22. It is envisioned that preform 18 may be formed without using a sprue or that preform 18 may be formed using a sprue, wherein the sprue is severed or otherwise removed from preform 18 prior disposing preform 18 in cavity 20. As such, portion 42 is maintained between portions 40 and 44 such that no portion of portion 40 extends through portion 40 or portion 44 when preform 18 is positioned within cavity 20, as described herein. In this configuration, portion 40 defines the outermost surface of bottom portion 35 along the entire length of bottom portion 35. Furthermore, bottom portion 35 has an arcuate portion between the sidewalls, wherein the arcuate portion is continuously curved between the sidewalls. That is, the arcuate portion is continuously curved from one of the sidewalls to the other one of the sidewalls when preform 18 is positioned within cavity 20, as described herein. In some embodiments, the arcuate portion has a continuous radius of curvature from one of the sidewalls to the other one of the sidewalls when preform 18 is positioned within cavity 20, as described herein.

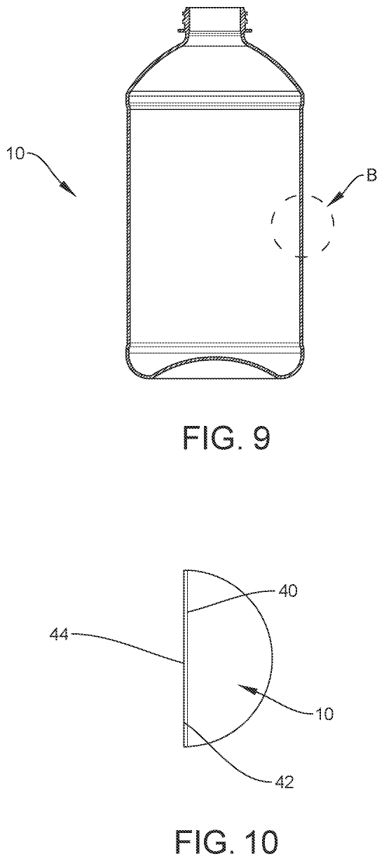

During the molding process, portions 40, 42, 44 are maintained such that portions 40, 42, 44 are also present in finished container 10, as shown in FIGS. 10 and 11. It has been found that the configuration of portions 40, 42, 44 discussed above makes the one or more concentrated additives in portion 42 function more effectively that if the one or more additives were dispersed in each of portions 40, 42, 44. For example, when the one or more concentrated additive in portion 42 is an oxygen scavenger, such as, for example, one or more of the oxygen scavengers discussed herein, the concentrated oxygen scavenger decreases the level of oxygen in container 10 more effectively than if the oxygen scavenger was also included in portions 40, 44. This will prevent or reduce the amount of oxygen that will be able to enter the inside of container 10, hence extending the shelf life of any food and/or beverage product within container 10. Indeed, the configuration of portions 40, 42, 44 discussed above allows portion 42 to form a barrier that prevents or reduces the ability of oxygen to move from the environment surrounding container 10 to the inside 15 of container 10.

In some embodiments, portion 42 of container 10 comprises less than 5% of a wall thickness of container 10, wherein the wall thickness of container 10 is defined by the combined thicknesses of portion 40, portion 42 and portion 44 of container 10. In some embodiments, portion 42 of container 10 comprises less than 10% of the wall thickness of container 10. In some embodiments, portion 42 of container 10 comprises less than 15% of the wall thickness of container 10. In some embodiments, portion 42 of container 10 comprises less than 20% of the wall thickness of container 10. In some embodiments, portion 42 of container 10 comprises less than 25% of the wall thickness of container 10. In some embodiments, portion 42 of container 10 comprises less than 30% of the wall thickness of container 10.

In some embodiments, the single portion of top portion 25 has the same thickness in container 10 as the combined thickness of portions 40, 42, 44. In some embodiments, portions 40, 42, 44 each have the same thickness in container 10. In some embodiments, at least one of portions 40, 42, 44 in container 10 has a thickness that is greater than a thickness of another one of portions 40, 42, 44 in container 10. In some embodiments, at least one of portions 40, 42, 44 in container 10 has a thickness that is less than a thickness of another one of portions 40, 42, 44 in container 10. In some embodiments, portions 40, 44 each have the same thickness in container 10 and portion 42 has a thickness in container 10 that is different than the thicknesses of portions 40, 44. In some embodiments, portions 40, 44 each have the same thickness in container 10 and portion 42 has a thickness in container 10 that is greater than the thicknesses of portions 40, 44 in container 10. In some embodiments, portions 40, 44 each have the same thickness in container 10 and portion 42 has a thickness that is less than the thicknesses of portions 40, 44 in container 10.

In some embodiments, the two-stage method includes one or more steps in a second stage of the manufacturing operation. For example, in a step S3 of the second stage, preform 18 is provided having a dome forming surface 30, thread forming surface 24 and a body forming surface 32. In some embodiments, the second stage includes a step S4, which comprises pre-heating preform 18 to a temperature in a range of about 95 degrees Celsius (C) to about 110 degrees C. In some embodiments, the portion of preform 18 that includes the concentrated additives (the portion that includes portions 40, 42, 44) terminates below a trim point TP, as discussed herein, and that the portion of above the trim point includes a single portion that is free of any additives, such as, for example, the additives discussed herein.

In some embodiments, the second stage includes a step S5, which comprises mounting pre-heated preform 18 in place within cavity 20 of mold assembly 22. Mold assembly 22 has an interior mold surface shaped to correspond to the selected configuration of container 10. As discussed above, the interior mold surface can be shaped such that container 10 has any size and/or shape, depending upon the application. In some embodiments, the temperature of mold assembly 22 is in a range of about 40 degrees Fahrenheit (F) to about 110 degrees F. Preform 18 has a flange 34, which mounts on mold assembly 22 adjacent opening 28. In some embodiments, preform 18 has surface 30 that forms dome 36 of intermediate article 16, a surface 24 that forms neck 12 of intermediate article 16 and a surface 32 that forms body 38 of intermediate article 16. In some embodiments, preform 18 does not have surface 30 that forms dome 36 and is blow molded to form finished container 10 without dome 36, as discussed herein. That is, preform 18 is configured to not form dome 36 such that no trimming of dome 36 is required to produce finished container 10. In some embodiments, surface 30 has a wall thickness in a range of about 0.100 inches (in) to about 0.300 in. In some embodiments, surface 24 has a wall thickness in a range of about 0.100 in to about 0.300 in. In some embodiments, surface 32 has a wall thickness in a range of about 0.100 in to about 0.300 in.

A step S6 includes blowing air into preform 18 to mold intermediate article 16, as shown in FIG. 4. In some embodiments, air is blown from a compressor and at a pressure in a range of about 35 to about 40 bar blown into an open end 40 of preform 18 to stretch or extend surfaces 30, 24, 32 and a bottom surface 42 of preform 18 radially outwardly and axially downwardly against the interior molding surface of mold assembly 22, as shown in FIG. 3. A step S7 includes removing intermediate article 16 from mold assembly 22. In some embodiments, preform 18 has a diameter of about 3.3 inches adjacent surface 24 and a length of about 6.2 inches; and intermediate article 16 has a diameter of about 6 inches and a length of about 10.3 inches. In some embodiments, finished container 10, after trimming of intermediate article 16 as described herein, has a maximum diameter of about 7.25 inches.

In some embodiments, dome 36 is attached to an upper edge of neck 12 along an annular recess 44. In some embodiments, the second stage includes a step S8, which comprises removing and/or trimming off dome 36 from intermediate article 16 adjacent neck 12 with a trimming machine TM. Dome 36 is severed from intermediate article 16 to produce finished container 10, as shown in FIG. 3. As such, the second stage includes a step S9 of providing finished container 10. As discussed above, in some embodiments, intermediate article 16 is blown from preform 18 such that intermediate article 16 does not include dome 36. In such embodiments, step S8 is omitted. In some embodiments wherein intermediate article 16 does not include dome 36, intermediate 16 is finished container 10.

As discussed above, in embodiments wherein intermediate article 16 include dome 36, the portion of preform 18 that includes the concentrated additives (the portion that includes portions 40, 42, 44) terminates below the trim point and that the portion of above trim point TP includes a single portion that is free of any additives, such as, for example, the additives discussed herein. In that dome 36 is formed from the single portion of top portion 25 of preform that does not include any additives, dome 36 is free of any of the additives discussed above. In some embodiments, dome 36 is scrap material (post-industrial material) that may be reused in another manufacturing process, such as, for example, the manufacturing of another container, such as, for example, another container that is the same or similar to container 10.

In embodiments wherein intermediate article 16 include dome 36, dome 36 may be ground, blended, dried and added to a melt stream to produce a second preform. In some embodiments the melt stream includes virgin PET and/or post-consumer material without any other additives. In some embodiments the melt stream includes virgin PET and/or post-consumer material in addition to one or more of the additives discussed above. In some embodiments the melt stream includes virgin PET and/or post-consumer material without any other additives and one or more of the additives discussed above is added to the melt stream after ground, blended and dried dome 36 is added to the melt stream. The second preform is disposed in a mold, similar to step S3 discussed above. The second preform may then be pre-heated, similar to step S4 discussed above. In some embodiments, the preheated second preform is mounted in place within a cavity of a mold, such as, for example, cavity 20 of mold assembly 22, similar to step S5 discussed above. In some embodiments, the second preform is air blown to mold a second intermediate article similar to intermediate article 16, similar to step S6 discussed above. The second intermediate article is removed from the mold assembly, similar to step S7 discussed above. In some embodiments, a dome of the second intermediate article, similar to dome 36, is removed and/or trimmed off from the second intermediate article adjacent a neck of the second intermediate article that is similar to neck 12 with a trimming machine, such as, for example trimming machine TM. The dome of the second intermediate article is severed from the second intermediate article to produce a second finished container that is similar to finished container 10.

In some embodiments, the first container 10 and/or the second finished container, as described herein, can be fabricated from materials suitable for food packaging products. In some embodiments, such materials include synthetic polymers such as thermoplastics, semi-rigid and rigid materials, elastomers, fabric and/or their composites.

In some embodiments, the first container 10 and/or the second finished container, as described herein, can be fabricated from materials suitable for food packaging products. In some embodiments, such materials include biodegradable polymers, bio-derived polymers, polyester, HDPE, and polypropylene.

In some embodiments, wherein finished container 10 is produced without any trimming step, step S6 includes blowing air into preform 18 to form finished container 10 and step S7 includes removing finished container 10 from mold assembly 22. In such embodiments, steps S8 and S9 are excluded. In such embodiments, steps S8 and S9 are excluded, and finished container 10, such as, for example, a container that is the same or similar to that shown in FIG. 3A is produced after step S7.

In some embodiments, container 10 comprises PET and the method of making container 10 discussed above may be modified to, for example, vary the crystallinity of PET. In some embodiments, the method is configured to prevent crystallization such that the PET is amorphous. Such embodiments may be used in applications where it is desired that container 10 be clear and/or container 10 is not expected to encounter elevated temperatures or aggressive chemical environments. In some embodiments, the temperature that preform 18 is exposed to during the molding process may be limited such that the temperature does not exceed a selected threshold temperature to produce container 10 wherein the PET is amorphous. In some embodiments, the selected threshold temperature is above the glass-transition temperature of PET, but below the crystallization temperature of PET.

In some embodiments, it may be desired that the PET be semi-crystalline or crystalline. Such embodiments may be used in applications where it acceptable that container 10 has at least some degree of cloudiness and/or applications where it is desired that the PET be reinforced to provide added strength. It is envisioned that having container 10 include semi-crystalline or crystalline PET may be useful for applications wherein container 10 may encounter elevated temperatures or aggressive chemical environments. In some embodiments, glass fibers and/or mineral fillers are added to provide make the PET semi-crystalline or crystalline. In some embodiments, the temperature that preform 18 is exposed to during the molding process may be required to exceed a selected threshold temperature wherein the PET is not quenched rapidly to produce container 10 wherein the PET is semi-crystalline or crystalline. In some embodiments, the selected threshold temperature is above the crystallization temperature of PET. In some embodiments, the selected threshold temperature is below the melting temperature of PET. In some embodiments, the amount of time preform 18 is exposed to the selected temperature may be varied to achieve the desired amount of crystallinity. In some embodiments, preform 18 is stretched in place of or in addition to heating preform 18 during the molding process to exceed the selected temperature. In some embodiments, the PET used has a narrow molecular weight, linear polymer chain structure, and high molecular weight to make the PET semi-crystalline or crystalline. In some embodiments, nucleating agents are added to produce container 10 wherein the PET is semi-crystalline or crystalline. In some embodiments, the nucleating agents include, for example, talc, sodium benzoate and an ionomer. In some embodiments, pressure may be applied during the molding process to produce container 10 wherein the PET is semi-crystalline or crystalline. In some embodiments, moisture may be added to preform 18 during the molding process to produce container 10 wherein the PET is semi-crystalline or crystalline.

In some embodiments, the method is adapted in one or more of the ways discussed above to produce a container that has a crystallinity between about 5% and about 40%. In some embodiments, the method is adapted in one or more of the ways discussed above to produce a container that has a crystallinity of about 10%. In some embodiments, the method is adapted in one or more of the ways discussed above to produce a container that has a crystallinity between about 15% and about 20%. In some embodiments, the method is adapted in one or more of the ways discussed above to produce a container that has a crystallinity between about 20% and about 25%. In some embodiments, the method is adapted in one or more of the ways discussed above to produce a container that has a crystallinity between about 18% and about 30%. In some embodiments, the method is adapted in one or more of the ways discussed above to produce a container that has a crystallinity between about 20% and about 40%. In some embodiments, the crystallinity of container 10 may be modified such that container 10 comprises portions that contain strength hardened PET with the characteristics discussed above.

The b* measurement is one measurement used to determine the suitability of post-consumer containers for reuse in PET containers. The b* measurement is the yellow to blue vector of a three vector color graph. The yellow tone or color is typically used to indicate the degree of degradation of PET after processing and subsequent heat cycles. The more yellow the PET is, it is assumed that it is more degraded. And PET will degrade with each heat history that it is subjected to. So with each heat history the control or standard PET bottle is put through it will increase in yellow b* measurement. The APR Critical Guidance Recognition testing recognizes this and established a range that the bottle has to stay within. The Container must be +/−1.5 b* unit from the control bottle to pass the test. If the container is outside of this limit on b* measurement, it fails the test and is unsuitable for reuse in PET containers.

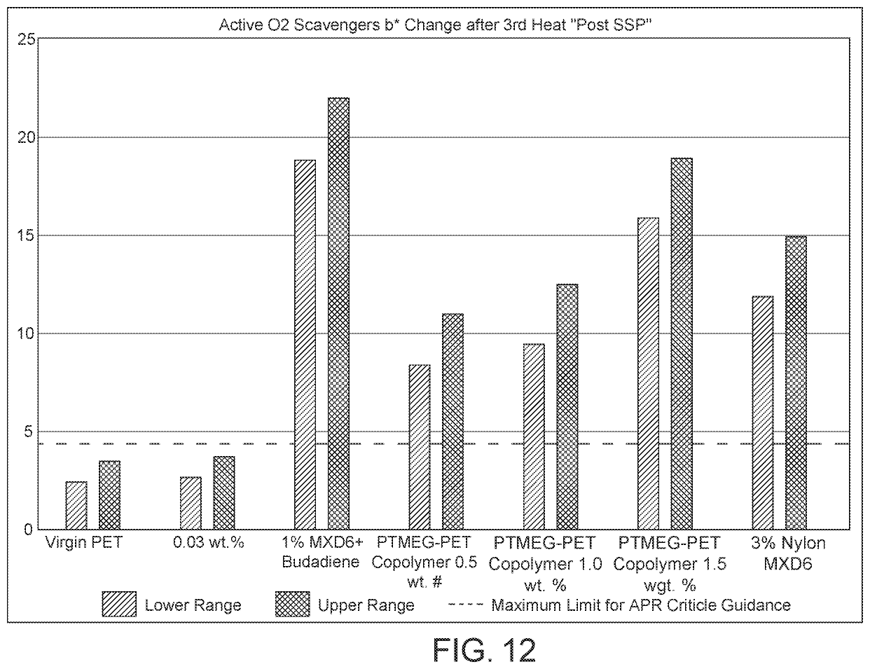

The *b measurements of a container 10 and several other containers have been compared with the *b measurements of virgin PET using the APR protocol discussed above to determine the suitability of the containers for reuse in PET containers. As shown in FIG. 12 container 10 has the closest b* to virgin PET of all of the samples that have been through the SSP test. That, the containers that include greater percentages of scavenger (e.g., Active Scavengers A-E) deviate from the b* measurement of virgin PET more so than container 10, which contains much less scavenger than conventional containers, such as, for example, Active Scavengers A-E. Notably, samples having a b* measurement of more than 5 (e.g., Active Scavengers A-E) exhibit a significant degree of yellowing that makes them unsuitable to make PET containers. Active Scavengers A-E would hence would be unsuitable for use as material 60. In that container 10 behaves similar to virgin PET and has a b* measurement of less than 5, container 10 would be suitable for use as material 60. As such, the relatively low amount of oxygen scavenger and/or other additives in container 10 makes container 10 suitable for reuse in PET containers, while other containers that include higher amounts of oxygen scavenger and/or other additives are not suitable for reuse in PET containers. It is noted that in the comparison discussed in this paragraph, the “Virgin PET” range maximum is 3.5 b* units, so the maximum b* limit (dashed line) was set at 5 b* units. The minimum is not relevant to this group and hence is not represented.

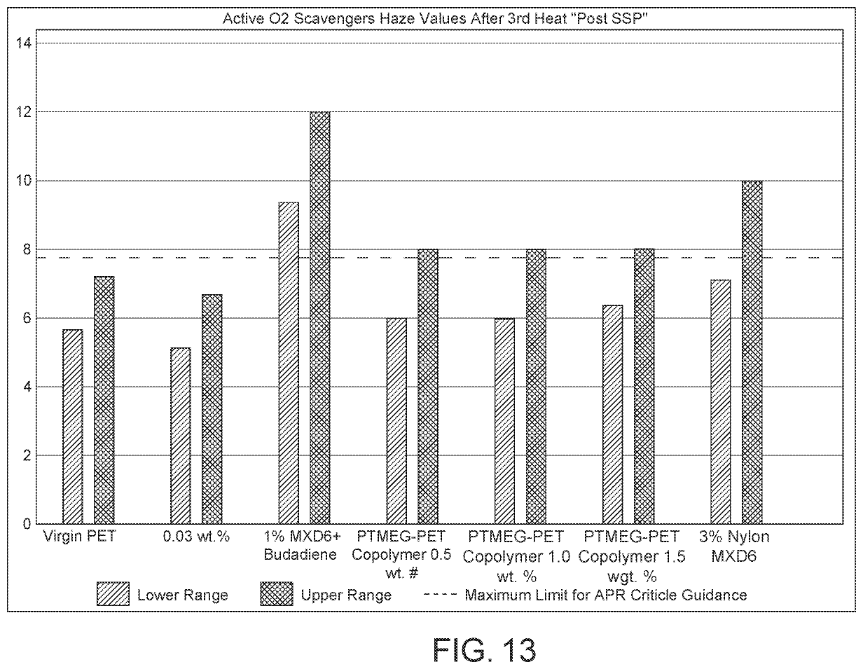

The haze percentage of a container 10 and the other containers discussed in connection with FIG. 12 have been compared with the haze percentage of virgin PET using the APR protocol discussed above to determine the suitability of the containers for reuse in PET containers. The control bottle (“Virgin PET)” has to measure less than 9% haze value to be acceptable. Then once that is established, plaque samples of the containers that are being compared with the control bottle have to be with 10% of the measurement of the control bottle. So the highest haze value of the represented control was 7.0 and 10% of that is 0.7, which is indicated in FIG. 13 by dashed line to show the maximum haze percentage for each sample. As shown in FIG. 13, the haze percentage of container 10 is below 7 and is hence reusable in PET containers. The other samples, however, have haze percentages above 7 and are hence unsuitable for reuse in PET containers. Again, the relatively low amount of oxygen scavenger and/or other additives in container 10 makes container 10 suitable for reuse in PET containers, while other containers that include higher amounts of oxygen scavenger and/or other additives are not suitable for reuse in PET containers.

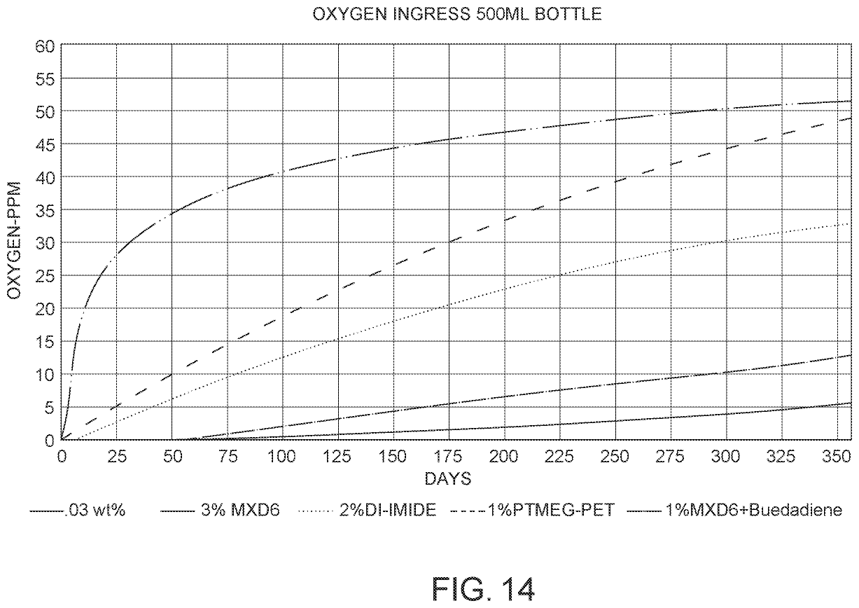

One way to measure the effectiveness and strength of O2 scavengers is fill containers with deoxygenated water, seal the containers and measure the O2 in the water over time. The O2 level in the water increases as O2 permeates through the container (walls, seals, caps, etc. . . . ) and the increase in O2 levels measured in PPM (parts per million) over time. The chart in FIG. 14 shows four alternative active scavengers to the 0.03 wt. % active scavenger referenced in this document. The number of days the containers are in the test is the X axis and the resulting O2 levels measured inside of the sealed containers is the Y axis. The solid line indicates the performance of the 0.03 wt. % container.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

1. A method for manufacturing containers, the method comprising the steps of:
forming a top portion of a preform by injecting a first material into a mold; and
forming a bottom portion of the preform by injecting a second material into the mold to form inner and outer layers of the bottom portion and injecting a third material into the mold to form an intermediate layer of the bottom portion that is positioned between the inner layer and the outer layer,
wherein the third material comprises virgin polyethylene terephthalate and an additive, the additive being present in an amount between about 0.01 wt. % and about 0.1 wt. % of the preform.

2. The method recited in claim 1, wherein at least one of the first material and the second material comprises recycled polyethylene terephthalate.

3. The method recited in claim 1, wherein the first material and the second material each comprise recycled polyethylene terephthalate.

4. The method recited in claim 1, wherein at least one of the first material and the second material comprises recycled polyethylene terephthalate and virgin polyethylene terephthalate.

5. The method recited in claim 1, wherein the first material and the second material each comprise recycled polyethylene terephthalate and virgin polyethylene terephthalate.

6. The method recited in claim 1, wherein the third material comprises recycled polyethylene terephthalate, the virgin polyethylene terephthalate and the additive.

7. The method recited in claim 1, wherein the third material comprises recycled polyethylene terephthalate, the virgin polyethylene terephthalate and the additive, the third material having a greater weight percentage of the recycled polyethylene terephthalate than the virgin polyethylene terephthalate.

8. The method recited in claim 1, wherein the third material comprises 75-99% recycled polyethylene terephthalate, 1-25% the virgin polyethylene terephthalate and the additive.

9. The method recited in claim 8, further comprising:
blow molding the preform into an intermediate article; and
processing the intermediate article to produce a finished container.

10. The method recited in claim 8, wherein the additive comprises at least one of the group consisting of passive oxygen scavengers and active oxygen scavengers.

11. The method recited in claim 1, wherein the third material consists of the virgin polyethylene terephthalate and the additive.

12. The method recited in claim 1, wherein the first material and the second material each comprise recycled polyethylene terephthalate, the first and second materials each comprising a greater percentage of the recycled polyethylene terephthalate than the third material.

13. The method recited in claim 1, wherein the first material and the second material each comprise recycled polyethylene terephthalate, the first and second materials each comprising a greater percentage of the recycled polyethylene terephthalate than the third material.

14. The method recited in claim 1, wherein the first material and the second material each comprise recycled polyethylene terephthalate, the third material comprising 1-99% of the recycled polyethylene terephthalate, the first material and the second material each comprising 1-99% of the recycled polyethylene terephthalate.

15. The method recited in claim 1, wherein the first material and the second material each comprise recycled polyethylene terephthalate, the third material comprising 1-10% of the recycled polyethylene terephthalate, the first material and the second material each comprising 1-90% of the recycled polyethylene terephthalate.

16. The method recited in claim 1, wherein the first material and the second material each comprise recycled polyethylene terephthalate, the third material comprising 1-5% of the recycled polyethylene terephthalate, the first material and the second material each comprising 1-95% of the recycled polyethylene terephthalate.

17. The method recited in claim 1, wherein the first material and the second material each comprise recycled polyethylene terephthalate, the third material comprising 1-2% of the recycled polyethylene terephthalate, the first material and the second material each comprising 1-98% of the recycled polyethylene terephthalate.

18. The method recited in claim 1, wherein the first material and the second material each comprise recycled polyethylene terephthalate, the third material comprising less than 1-2% of the recycled polyethylene terephthalate, the first material and the second material each comprising at least 99% of the recycled polyethylene terephthalate.

19. A method for manufacturing containers, the method comprising the steps of:
grinding a polyethylene terephthalate container into a first material;
forming a top portion of a preform by injecting the first material into a mold;
forming a bottom portion of the preform by injecting a second material into the mold to form inner and outer layers of the bottom portion and injecting a third material into the mold to form an intermediate layer of the bottom portion that is positioned between the inner layer and the outer layer;
blow molding the preform into an intermediate article; and
processing the intermediate article to produce a finished container,
wherein the first material comprises polyethylene terephthalate and a first additive, and
wherein the third material comprises virgin polyethylene terephthalate and a second additive, the second additive comprising at least one of the group consisting of passive oxygen scavengers and active oxygen scavengers, the second additive being present in an amount between about 0.01 wt. % and about 0.1 wt. % of the finished container.

20. The method recited in claim 19, wherein the second material is different than the first material.

21. The method recited in claim 19, wherein the second material is the same as the first material.

22. The method recited in claim 19, wherein the third material consists of the virgin polyethylene terephthalate and the second additive.

23. The method recited in claim 19, wherein the third material further comprises the first material.

24. The method recited in claim 19, wherein the third material comprises 75-99% of the first material and 1-25% virgin polyethylene terephthalate.

25. The method recited in claim 19, wherein the second material consists of the first material.

26. The method recited in claim 19, wherein the second material consists of the first material and virgin polyethylene terephthalate.

27. The method recited in claim 19, wherein the second material comprises 75-99% of the first material and 1-25% virgin polyethylene terephthalate.

28. A method for manufacturing containers, the method comprising the steps of:
grinding a plurality of polyethylene terephthalate containers into a first material;
forming a top portion of a preform by injecting the first material into a mold such that the top portion includes only one layer consisting of the first material;
forming a bottom portion of the preform that is connected to the top portion by injecting the first material into the mold to form inner and outer layers of the bottom portion and injecting a second material into the mold to form an intermediate layer of the bottom portion that is positioned between the inner layer and the outer layer;
blow molding the preform into an intermediate article; and
processing the intermediate article to produce a finished container,
wherein the first material comprises polyethylene terephthalate and a first additive,
wherein the second material comprises 1-25% virgin polyethylene terephthalate, 75-99% polyethylene terephthalate and a second additive, and
wherein the second additive comprises at least one of the group consisting of passive oxygen scavengers and active oxygen scavengers, the second additive being present in an amount between about 0.01 wt. % and about 0.1 wt. % of the finished container.
